(19) United States
(12) Patent Application Publication
(10) Pub. No.: US 2003/0039462 A1
(43) Pub. Date: Feb. 27, 2003

(54) Method for efficiently determining optical fiber parameters enabling supercontinuum (SC) generation in optical fiber

(76) Inventors: Luc Boivin, Eatontown, NJ (US); Stefano Taccheo, Milano (IT)

Correspondence Address: Thomason, Moser & Patterson, LLP, Attorneys At Law, Suite 100, 595 Shrewsbury Avenue, Shrewsbury, NY, 07702, US

(21) Appl. No.: 09/858,196

(22) Filed: May 15, 2001

(51) Int. Cl. G02B 6/00; G02B 6/26

(52) U.S. Cl. 385/147; 385/39

(57) ABSTRACT

A method for determining at least one of the maximum magnification and corresponding fiber lengths associated with a single-mode optical fiber having a normal dispersion such that supercontinuum generation within this fiber may be achieved.

### TECHNICAL FIELD

The invention relates to the field of communications systems and, more specifically, a method for determining the properties of an optical fiber supportive of supercontinuum (SC) generation.

### BACKGROUND OF THE INVENTION

Supercontinuum (SC) generation in optical fiber finds application in, for example, transmitters within multi-wavelength transmission systems. Specifically, short optical pulses having high peak power are propagated in an optical fiber to generate a broad optical spectrum which is then sliced into many wavelength channels. The supercontinuum properties depend on the shape and the peak power of the pulses as well as on fiber dispersion, fiber length and on the interplay with non-linear processes. When these parameters are not balanced properly, the optical spectrum obtained through supercontinuum generation is of poor quality and cannot be used in the context of wavelength division multiplexing. The poor quality of the spectrum manifests itself either as insufficient bandwidth and/or as a high level of amplitude noise in the sliced spectrum.

Numerical simulations based on the nonlinear Schrödinger equation can be used to study the quality of optical spectra obtained through supercontinuum generation for a large range of seed pulse and fiber parameters. These simulations are however time consuming and computationally inefficient at determining optimum conditions for supercontinuum generation.

### SUMMARY OF THE INVENTION

The present invention generally comprises a method for determining at least one of the maximum optical spectrum magnification and corresponding fiber lengths associated with a single-mode optical fiber having normal dispersion such that supercontinuum generation within this fiber may be achieved within the context of a wave division multiplexing (WDM) system.

Given, for example, a predefined pulse shape, duration and peak power, the invention provides a computationally efficient method of determining optimum parameters of single-mode optical fiber supportive of supercontinuum generation while restraining amplitude noise across the supercontinuum spectrum. Similarly given a fiber with predefined length, dispersion and nonlinear coefficient, the invention provides a computationally efficient method for determining the optimum pulse duration and peak power to achieve supercontinuum having a broad spectrum and low amplitude noise. The invention can be applied to seed pulses selectively approximating either Gaussian or sech distributions.

### BRIEF DESCRIPTION OF THE DRAWINGS

So that the manner in which the above-recited features, advantages and objects of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a high level block diagram of transmitter apparatus according to the present invention;

FIG. 2 depicts a high level block diagram of an exemplary parameter selector suitable for use in the transmitter apparatus of FIG. 1;

FIG. 3 depicts a flow diagram of a problem space reduction method according to the present invention;

FIG. 4 depicts graphical representations of pulse spectrum evolutions useful in understanding the present invention;

FIG. 5 depicts a graphical representation of optical fiber length and maximum magnification as a function of N for an optical fiber; and

FIG. 6 depicts a flow diagram of a method according to the present invention.

To facilitate understanding, identical reference numerals have been used, where possible, to designate identical elements that are common to the figures.

### DETAILED DESCRIPTION OF THE PREFERRED EMBODIMENT

The invention will be described within the context of the processing of a particular equation to derive a mathematical relationship between an output data sub-set and a corresponding input data sub-set. It will be appreciated by those skilled in the art that the teachings of the present invention have applicability to other equations and/or data relationships.

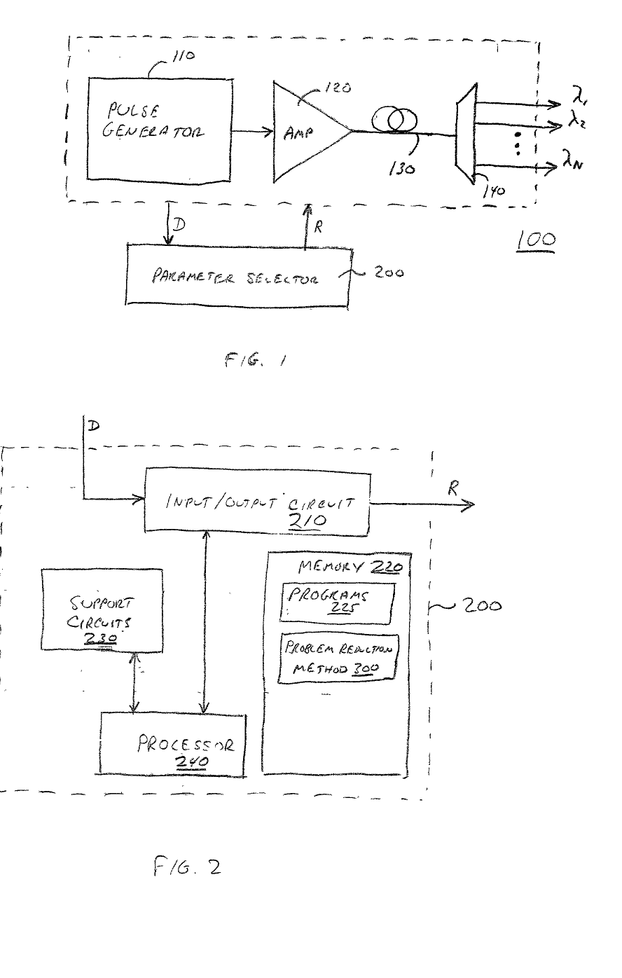

FIG. 1 depicts a high level block diagram of transmitter apparatus according to the present invention. Specifically, the apparatus 100 of FIG. 1 comprises a pulse generator 110, an amplifier 120, an optical fiber 130, a wavelength demultiplexer 140 and a parameter selector 200.

The pulse generator 110 generates an optical seed pulse having, illustratively, a Gaussian or sech characteristic. The pulse shape characteristic may be selected via the parameter selector 200. The optical seed pulse is amplified by the amplifier 120 and provided to the optical fiber 130. The optical fiber 130 comprises a single-mode optical fiber capable of supporting supercontinuum operation where an appropriate fiber length and optical input power are present. The wavelength demultiplexer 140 slices the supercontinuum into a number N of pulse streams (denoted as λ₁ through λ_{N} having different carrier wavelengths. By proper selection of the wavelength demultiplexer, the carrier wavelengths can be aligned, for example, to a standard telecommunication grid.

It is noted that other processing functions are performed within a typical transmitter, though these functions are not shown. That is, the apparatus 100 of FIG. 1 may include, or be adapted to cooperate with, other processing apparatus such as N data-encoding modulators (one per pulse stream λ₁ through λ_{N}), synchronizing electronics to align the pulse streams to the respective data encoders, polarization controlling optics and electronics to align the polarization of the pulse streams to the preferred polarization state of the modulators, forward-error correcting electronics, a wavelength division multiplexer, a channel power equalizer and generally other optical and electronics elements necessary to support dense wave division multiplexing (DWDM) applications.

The parameter selector 200 receives decision criteria D and responsively produces a result R. The decision criteria comprises, illustratively, the pulse shape, the pulse duration, the pulse peak power, the fiber dispersion parameter and the fiber nonlinear coefficient. The result R comprises the length of the optical fiber 130 for maximum spectrum magnification as well as the corresponding maximum magnification factor.

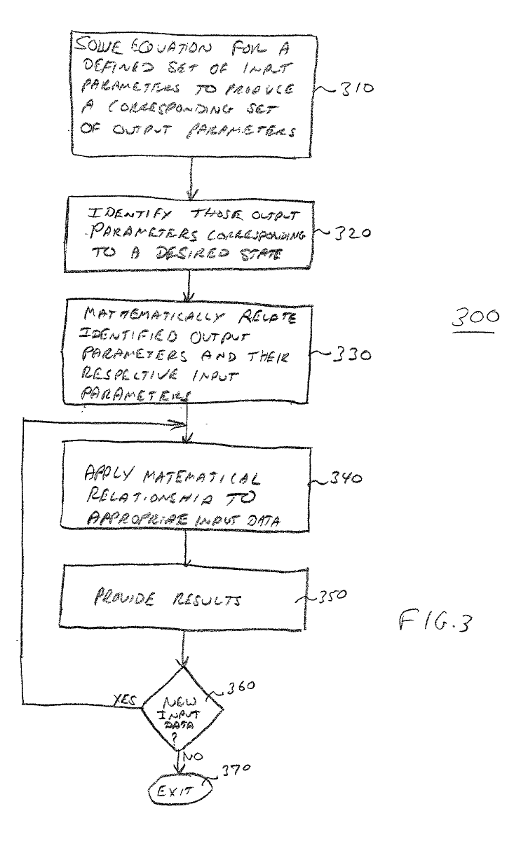

FIG. 2 depicts a high level block diagram of an exemplary parameter selector suitable for use in the transmitter apparatus of FIG. 1 in the present invention. Specifically, the parameter selector 200 of FIG. 2 contains a processor 240 as well as memory 220 for storing programs 225 supporting the methods of the present invention and any necessary functionality. The memory 220 also stores a problem space reduction method 300 suitable for determining appropriate fiber optic parameters in a computationally efficient manner. The processor 240 cooperates with conventional support circuitry 230 such as power supplies, clock circuits, cache memory and the like as well as circuits that assist in executing the software routines. As such, it is contemplated that some of the process steps discussed herein as software processes may be implemented within hardware, for example, as circuitry that cooperates with the processor 240 to perform various steps. The parameter selector 200 also contains input/output circuitry 210 that forms an interface between conventional input/output (I/O) devices, such as a keyboard, mouse and display (not shown) as well as an interface to the optical pulse generation and propagation circuitry discussed above with respect to the apparatus 100 of FIG. 1.

Although the parameter selector 200 is depicted as a general purpose computer that is programmed to determine appropriate parameters for optical fiber 130 in accordance with the present invention, the invention can be implemented in hardware as an application specific integrated circuit (ASIC). As such, the process steps described herein are intended to be broadly interpreted as being equivalently performed by software, hardware ,a combination thereof.

The parameter selector 200 of the present invention executes, inter alia, a problem reduction method 300 that reduces the problem space associated with determining appropriate parameters for implementing an optical fiber 130 according to desired criteria. The problem space reduction method 300 will be discussed in more detail below with respect to FIG. 3.

FIG. 3 depicts a flow diagram of a problem space reduction method according to the present invention. The method 300 of FIG. 3 is directed to providing a reduction in problem space such that one or both of an optimum fiber length and an optimum spectrum magnification factor may be determined in a computationally efficient manner for the optical fiber 130 in the apparatus 100 of FIG. 1.

At step 310, an equation is solved for a defined set of input parameters D to produce a corresponding set of output parameters R. That is, at step 310, multiple input parameters are processed and, optionally, repeatedly processed to provide a corresponding set of output parameters or sets of output parameters. In a preferred embodiment, the known non-linear Schrödinger equation is utilized. The Schrödinger equation is set forth below as equation 1:

$$i \frac{\partial A}{\partial z} = \frac{1}{2} {β}_{2} \frac{{\partial }^{2} A}{\partial {t}^{2}} + γ {\vert A \vert}^{2} A \qquad Equation 1$$

where:

| | |
|---|---|
| A represents | the envelope of the electric field; |
| z represents | the propagation distance along the fiber, t is time; |
| i represents | the imaginary number of magnitude unity; |
| β₂ represents | the dispersion parameter; and |
| γ represents | the nonlinear parameter. |

At step 320, those output parameters corresponding to a desired state are identified. That is, at step 320 a sub-set of the output parameters produced or synthesized at step 310 corresponding to a desired state of operation or other desired parameter is identified. In the preferred embodiment where the non-linear Schrödinger equation is processed, those output parameters indicative of a supercontinuum state of operation for an optical fiber are identified.

At step 330, the identified output parameters of step 320 are mathematically related to their corresponding input parameters. That is, given a desired sub-set of output parameters, a mathematical relationship is determined which relates the desired output parameters with their corresponding input parameters. It is noted that the mathematical relationship determined at step 330 comprises a reduced complexity equation as compared to the equation used at step 310. At step 330, the relatively complex equation utilized at step 310 is reduced to a computationally efficient mathematical relationship or equation wherein a sub-set of desired output parameters (identified at step 320) is used to remove (for example) non-critical criteria.

At step 340, the mathematical relationship determined at step 330 is applied to appropriate input data. That is, at step 340 appropriate input data, such as parameters related to the selection of an optical fiber, are processed according to the determined mathematical relationship. At step 350, the results are provided such that appropriate modifications may be made to, for example, the optical fiber 130. At step 360, a determination is made as to whether new input data is to be processed. If new input data is to be processed, then steps 340 through 360 are repeated. Otherwise, the method 300 exits at step 370.

In the preferred embodiment of the present invention, the method 300 of FIG. 3 is used to reduce the problem space associated with selecting the peak power of the seed pulses, the optical fiber length and/or the dispersion and nonlinearity of the fiber to achieve maximum spectrum magnification. In this embodiment, the well known non-linear Schrödinger equation is utilized at step 310 to process the electric field produced by a generator of Gaussian or sech seed pulses and to produce therefrom a spectrum corresponding propagation of these pulses through a fiber. set of output parameters. In this embodiment, the input parameters comprise various seed pulses which, when processed according to the non-linear Schrödinger equation, provide a set of output parameters depicting a specific spectrum evolution when plotted.

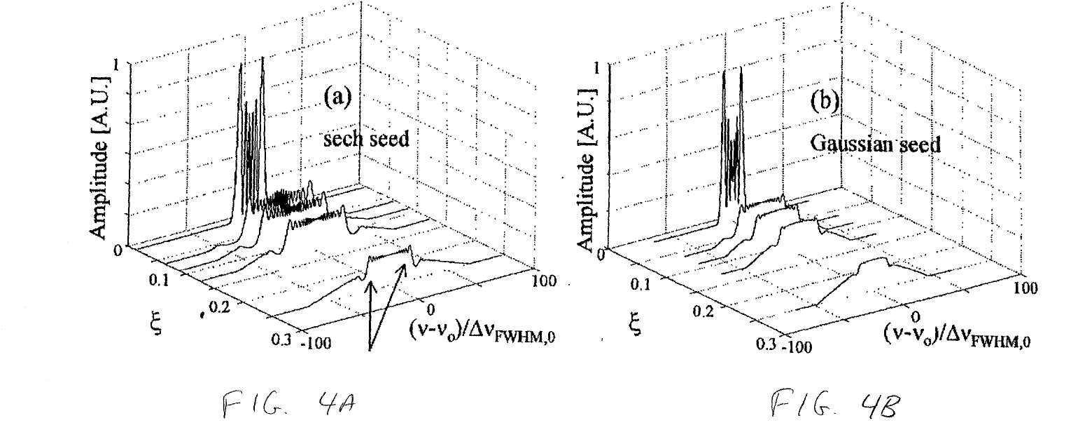

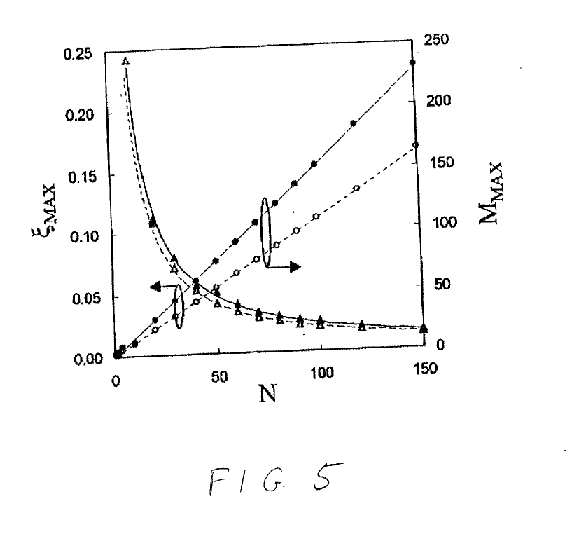

FIGS. 4A and 4B show the spectrum evolution of N=40 sech and N=40 Gaussian pulses respectively. As shown by these simulations, the spectrum evolution can be divided into two stages. First, the spectrum rapidly expands due to self-phase modulation (SPM). The central portion of the spectrum eventually reaches a maximum with and further propagation results in its spectral narrowing. Contemporaneously, energy is transferred to the “wings,” of the wave shapes via (primarily) four-wave mixing. All along propagation, dispersion interplay with SPM smooths amplitude ripples in the central portion of the supercontinuum (SC) spectrum.

The inventors have determined that chirp accumulation has a relatively large impact on SC generation characteristics. FIG. 4B shows that Gaussian pulses generate a flatter spectrum with higher side “wings” due to the more linear accumulated chirp. Third order dispersion has two main effects, namely: (1) tilting the resulting spectrum toward the long wavelength side and (2) the zero-wavelength becoming the upper limits for the achievable SC spectrum. The inventors have performed simulations and experiments to show that propagation of a portion of the SC in the anomalous regime degrades SC quality. Thus, dispersion flattened fibers are preferred for generating bandwidth greater than approximately 20-nanometers. It is also noted that low dispersion reduces the required input power.

Thus, in step 310, the influence of fiber, seed pulse parameters and seed pulse shape is noted by solving the non-linear Schrödinger equation for a given seed pulse. A particular pulse generator 110 used to provide such a seed pulse in the apparatus 100 of FIG. 1 may be characterized in its operation. In this manner, given a particular optical fiber or a particular level of amplification, the corresponding amount of amplification provided by amplifier 120 or length of optical fiber 130 may be rapidly and efficiently determined.

In the preferred embodiment, those upper parameters corresponding to a desired state are identified at step 320. Referring now to FIG. 5, this figure depicts a graphical representation of optical fiber length and maximum magnification as a function of N for an optical fiber. Using the data provided in FIG. 5, those upper parameters corresponding to the desired (i.e., supercontinuum) state are identified.

FIG. 5 depicts a graphical representation of optical fiber length and maximum magnification as a function of N for an optical fiber.

FIG. 5 shows the maximum magnification M_{MAX} and the corresponding optimum fiber length ξ_{MAX} values as circles and triangles, respectively; filled points refer to sech pulse and empty points refer to Gaussian pulse. The pertinent information within FIG. 5 is the solid lines representing fittings of M_{MAX} and and ξ_{MAX} by ^{˜}N and ^{˜}1/N analytic functions respectively. Thus, based on the data illustrated by FIG. 5, the following mathematical relationships may be established:

M_{MAX}≡αN Equation 2a

where:

| | |
|---|---|
| M_{MAX} represents | the maximum magnification factor; |
| N represents | the square root of ratio of dispersion and nonlinear |
| | lengths; |
| α represents | the proportionality constant (α = 1.5 or 1.1 for sech |
| | and Gaussian pulses respectively) |

Equation 2a is related to the following equation:

B∝N/T₀ Equation 2b

where:

| | |
|---|---|
| B represents | the output bandwidth; and |
| Tₒ represents | the initial pulse width of the seed pulses. |

In addition, the following relationship is derived:

ξ_{MAX}≅βN¹ Equation 3a

where:

| | |
|---|---|
| ξ_{MAX} represents: | the propagation normalized to the dispersion length; |
| β represents | a proportionality constant (beta = 2.4 or 2.1 for sech or |
| | Gaussian pulses respectively. |

Equation 3a is related to the following equation:

L_{f.MAX}∝/LₙL_{NL} Equation 3b

where:

| | |
|---|---|
| L_{f.MAX} represents: | the fiber length for optimum magnification; |
| Lₙ represents: | the dispersion length seed; and |
| L_{NL} represents: | the nonlinear length. |

Other known relationships useful in understanding the present invention are L_{D}=T₀²/β₂ and L_{NL}=1/P₀/Υ, where T₀ is the pulse width, β₂ is the second-order dispersion, P₀ is the peak power and Υ is the non-linear coefficient.

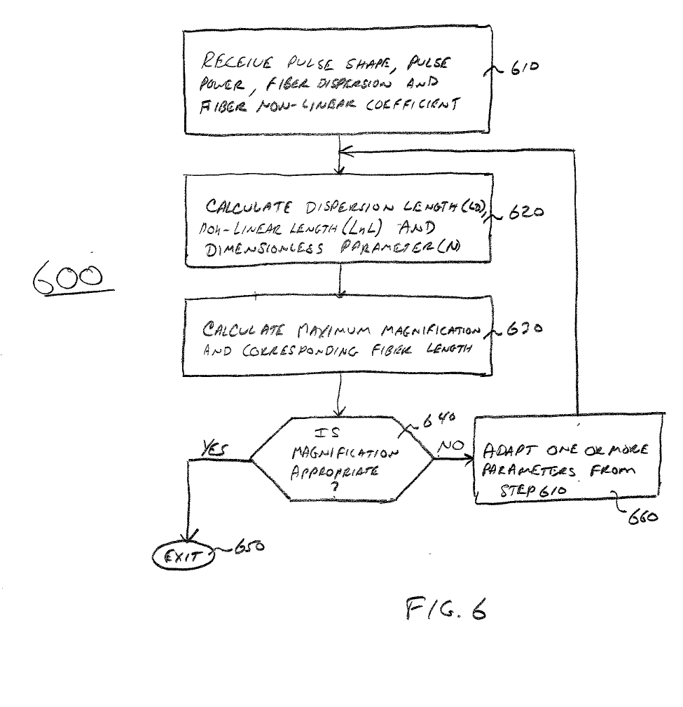

FIG. 6 depicts a flow diagram of a method according to the present invention. Specifically, FIG. 6 depicts a flow diagram of a method 600 for optimizing parameter in the apparatus 100 of FIG. 1.

At step 610, various parameters are received; namely, a pulse shape parameter (Gaussian or sech), a pulsewidth parameter, a pulse power parameter, a fiber dispersion parameter and a fiber non-linear coefficient parameter.

At step 620, the received parameters are used to calculate a dispersion length parameter L_{D}, a non-linear length parameter L_{NL} and a dimensionless parameter N.

At step 630, equations 2 and 3 are utilized to calculate the maximum magnification Mₘₐₓ and corresponding fiber length ξ_{MAX}.

At step 640, a determination is made as to whether the resulting level of magnification is appropriate to the amount of power to be applied by the pulse generator 110 and/or amplifier 120. If the magnification is appropriate, then the method 600 exits at step 650. If the magnification is not appropriate, then at step 660 one or more of the parameters of step 610 are adapted and steps 620 through 640 are repeated. It is noted that the pulse shape parameter may be adapted by selecting a different pulse shape, for example, a sech pulse instead of a Gaussian pulse. The pulse power parameter may be adapted by selecting a different amplifier, output level of an existing amplifier or pulse generator. The fiber dispersion parameter and fiber non-linear coefficient parameter may be adapted by selecting a different optical fiber. Other adaptations of the various parameters may be readily understood by those skilled in the art informed according to the teachings of the present invention.

In one experiment, the inventors proved the feasibility of a SC-based transmitter for dense wave division multiplex (DWDM) applications. Specifically, a ten-GB/S two-PS sech pulse train at 1554 nm was used to generate a SC spectrum in 4 km of dispersion-shifted fiber where D=−1.2 ps/nm/km and slope=0.07 ps/nm₂/km. The average patter was 610 milliwatts and was provided by a booster Er:Yb amplifier. To assess WDM potentiality of this source, the spectrum was sliced using a 40-channel 50 GHz demultiplexer. Pulses FWHM were 23.2 ps and no timing jitter were observed. Thus, the inventor's experiments show that with very little penalty the sliced pulse quality provided was very high and well suited for long-distance DWDM transmission.

Advantageously, the above-described invention operating in the preferred embodiment provides accurate and rapid prediction of the maximum broadening and the corresponding fiber length of an optical fiber without the need for additional numeric simulations. Thus, in the case of designing supercontinuum transmission sources, a given (i.e., characterized) amplifier or seed pulse having a defined strength may be used to rapidly calculate, using equation 3, the optimum fiber length of an optical fiber.

Although various embodiments which incorporate the teachings of the present invention have been shown and described in detail herein, those skilled in the art can readily devise many other varied embodiments that still incorporate these teachings.

1. A method for determining a parameter of an optical fiber to allow supercontinuum generation by said optical fiber, comprising:
determining a maximum magnification level according to the following equations:
M_{MAX}≡αN
B∝N/T₀
where:

| | |
|---|---|
| M_{MAX} represents | the maximum magnification factor; |
| N represents | the square root of ratio of dispersion and nonlinear |
| | lengths; |
| B represents | the output bandwidth; |
| ∝ represents | the proportionality constant; and |
| Tₒ represents | the pulse width. |

2. The method of claim 1, further comprising:
determining a corresponding fiber length according to the following equations:
ξ_{MAX}≅βN¹
L_{f.MAX}∝/LₙL_{NL}
where:

| | |
|---|---|
| ξ_{MAX} represents: | the propagation normalized to the dispersion length; |
| β represents | a proportionality constant; |
| L_{f.MAX} represents: | the fiber length for optimum magnification; |
| Lₙ represents: | the dispersion length seed; and |
| L_{NL} represents: | the nonlinear length. |

3. The method of claim 1, wherein the proportionality constant α comprises 1.5 for a sech pulse or 1.1 for a Gaussian pulse.

4. The method of claim 2, wherein the proportionality constant β comprises 2.4 for a sech pulse or 2.1 for a Gaussian pulse.

5. The method of claim 1, further comprising:
in the case of said maximum magnification being inappropriate, adapting at least one of a pulse shape parameter, a pulse power parameter, a fiber dispersion parameter and a fiber non-linear coefficient.

6. The method of claim 1, further comprising:
iteratively adapting at least one of a pulse shape parameter, a pulse power parameter, a fiber dispersion parameter and a fiber non-linear coefficient until said step of determining a maximum magnification level produces an appropriate result.

7. The method of claim 6, wherein an appropriate maximum magnification level result comprises a maximum magnification level compatible with an output power level of an amplifier coupled to said optical fiber.

8. The method of claim 5, wherein adapting a pulse shape parameter comprises selecting one of a sech pulse and a Gaussian pulse.

9. The method of claim 5, wherein said fiber dispersion parameter and fiber non-linear coefficients are adapted by selecting a different optical fiber.

10. A method, comprising:
solving a first equation for a defined set of input parameters to produce a corresponding set of output parameters;
identifying those output parameters corresponding to a desired state;
mathematically relating said identified output parameters and their respective input parameters; and
iteratively applying said mathematical relationship to a set of input parameters associated with a predefined optical fiber to produce a corresponding set of output parameters associated with said predefined optical fiber;
wherein said equation comprises a non-linear Schrödinger equation and said mathematical relationship comprises at least a relationship determining a maximum magnification level for said predefined optical fiber such that supercontinuum operation is supported by said optical fiber.

11. The method of claim 10, wherein said mathematical relationship also defines a fiber length for said predefined optical fiber.

12. The method of claim 10, wherein said maximum magnification level is determined according to the following equations:
M_{MAX}≡αN
B∝N/T₀
where:

| | |
|---|---|
| M_{MAX} represents | the maximum magnification factor; |
| N represents | the square root of ratio of dispersion and nonlinear |
| | lengths; |
| B represents | the output bandwidth; |
| ∝ represents | the proportionality constant; and |
| Tₒ represents | the pulse width. |

13. The method of claim 11, wherein said fiber length is determined according to the following equations:
ξ_{MAX}≅βN¹
L_{f.MAX}∝/LₙL_{NL}
where:

| | |
|---|---|
| ξ_{MAX} represents: | the propagation normalized to the dispersion length; |
| β represents | a proportionality constant; |
| L_{f.MAX} represents: | the fiber length for optimum magnification; |
| Lₙ represents: | the dispersion length seed; and |
| L_{NL} represents: | the nonlinear length. |

14. The method of claim 12, wherein the proportionality constant α comprises 1.5 for a sech pulse or 1.1 for a Gaussian pulse.

15. The method of claim 13, wherein the proportionality constant β comprises 2.4 for a sech pulse or 2.1 for a Gaussian pulse.

16. The method of claim 10, further comprising:
iteratively adapting at least one of a pulse shape parameter, a pulse power parameter, a fiber dispersion parameter, and a fiber non-linear coefficient until a determined maximum magnification level of said predefined optical fiber is appropriate.

17. The method of claim 16, wherein an appropriate maximum magnification level comprises a maximum magnification level compatible with an output power level of an amplifier coupled to said optical fiber.

18. The method of claim 16, wherein adapting a pulse shape parameter comprises selecting one of a sech pulse and a Gaussian pulse.

19. The method of claim 16, wherein said fiber dispersion parameter and fiber non-linear coefficients are adapted by selecting a different optical fiber.

20. Apparatus, comprising:
a pulse generator, for generating an optical seed pulse; and
an amplifier, coupled to said pulse generator and providing an amplified optical seed pulse to an optical fiber supportive of supercontinuum generation;
said optical fiber having a maximum magnification level determined according to the following equations:
M_{MAX}≡αN
B∝N/T₀
where:

| | |
|---|---|
| M_{MAX} represents | the maximum magnification factor; |
| N represents | the square root of ratio of dispersion and nonlinear |
| | lengths; |
| B represents | the output bandwidth; |
| ∝ represents | the proportionality constant; and |
| Tₒ represents | the pulse width. |

21. The apparatus of claim 20, wherein said optical fiber has a fiber length determined according to the following equations:
ξ_{MAX}≅βN¹
L_{f.MAX}∝/LₙL_{NL}
where:

| | |
|---|---|
| ξ_{MAX} represents: | the propagation normalized to the dispersion length; |
| β represents | a proportionality constant; |
| L_{f.MAX} represents: | the fiber length for optimum magnification; |
| Lₙ represents: | the dispersion length seed; and |
| L_{NL} represents: | the nonlinear length. |

22. The apparatus of claim 20, wherein:
in the case of said maximum magnification being inappropriate, adapting at least one of a pulse shape parameter, a pulse power parameter, a fiber dispersion parameter and a fiber non-linear coefficient.

23. The apparatus of claim 22, wherein an appropriate maximum magnification level result comprises a maximum magnification level compatible with an output power level of said amplifier.

24. The apparatus of claim 22, wherein said pulse shape parameter comprises selecting one of a sech pulse and a Gaussian pulse.

25. The apparatus of claim 22, wherein said fiber dispersion parameter and fiber non-linear coefficients are adapted by selecting a different optical fiber.
